(19) United States
(12) Patent Application Publication
(10) Pub. No.: US 2005/0273756 A1
(43) Pub. Date: Dec. 8, 2005

(54) Memory management method for multifunction peripheral

(76) Inventor: Xing-Ping Zhou, Beijing (CN)

Correspondence Address: HARNESS, DICKEY & PIERCE, P.L.C., P.O. BOX 8910, RESTON, VA, 20195, US

(21) Appl. No.: 10/861,282

(22) Filed: Jun. 4, 2004

(51) Int. Cl. G06F 9/44

(52) U.S. Cl. 717/100

(57) ABSTRACT

A memory management method for a MFP is disclosed. First of all, receive a request of executing an appointed function and then check available memory for executing such request. If the available memory is not enough for the job, then indicate this situation. Close at least one presently idle function to release its corresponding memory. Allocate the released memory for execution of the appointed function. After the appointed function has been finished, the closed function is re-opened. Thereby, the memory can be flexibly allocated as desired without manual operation.

### BACKGROUND OF THE INVENTION

1. Field of Invention

The present invention relates to a memory management method, especially a memory management method for a multifunction peripheral.

2. Related Art

As information technology develops rapidly, the multifunction peripheral (MFP), which is small in size, is produced to meet the requirements of processing more and more daily fairs and interchange data. Such a MFP becomes a commercial success due to its price advantage.

The MFP is an end office facility that prints, copies, scans and does facsimile jobs. The standard capacity of the memory is usually 32 Mbytes. The sub-memory allocated to execute each function is very limited. Every time when a lot of memory is needed to execute jobs, such as collation, duplication, A3-size copy and heavy font downloading, the memory overflows. Usually, the user needs to purchase an additional memory bar to increase the memory capacity. This is quite expensive.

### SUMMARY OF THE INVENTION

The invention provides a memory management method for the MFP, which reduce the possibility to buy extra memory when execution of an appointed function.

In order to achieve the above and other objectives, the invention provides a memory management method for an MFP. First, a request of executing an appointed function is received and the available memory for executing the appointed function is then checked. If the available memory is insufficient, then produce a cue. Currently idle functions are closed to release corresponding sub-memories. The total available memory is allocated for execution of the appointed function.

In the invention, when the single-function memory is not enough, an operation system of the business machine automatically closes currently idle functions to release more memory for execution of an appointed function. Therefore, additional memory capacity to support the execution of multiple functions is less needed. After the appointed function has been executed, the released memory returns to do its initially allocated job.

### BRIEF DESCRIPTION OF THE DRAWINGS

FIG. 1 is an overall flowchart of the memory management of a MFP;

FIG. 2 is a flowchart of the memory management of a MFP to the first embodiment of the invention;

FIG. 3a and FIG. 3b are schematic view illustrating the memory allocation according to one embodiment of the invention; and

FIG. 4 is a flowchart of a memory management method according to the second embodiment of the invention.

### DETAILED DESCRIPTION OF THE INVENTION

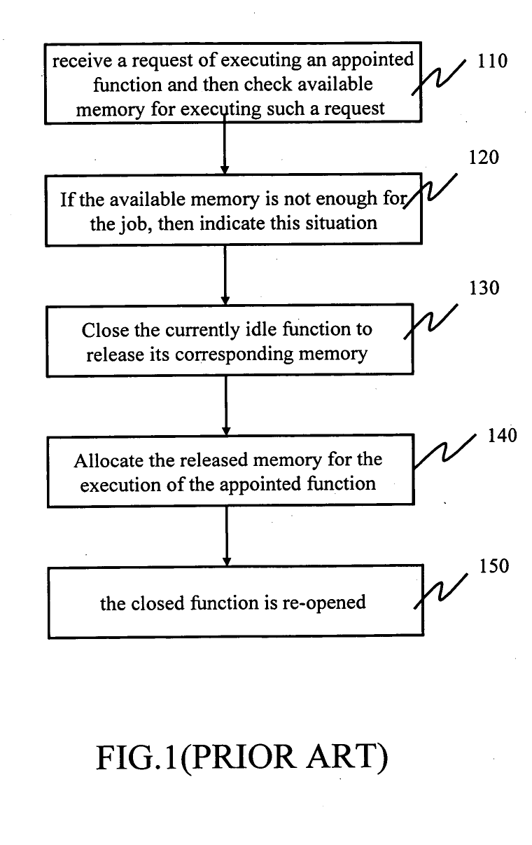

FIG. 1 is an overall flowchart of the memory management in a MFP. First of all, receive a request of executing an appointed function and then check available memory for executing such a request (step 110). If the available memory is not enough for the job, then indicate this situation (step 120). Close the currently idle function to release its corresponding memory (step 130). Allocate the released memory for the execution of the appointed function (step 140). After the appointed function has been finished, the closed function is re-opened (step 150).

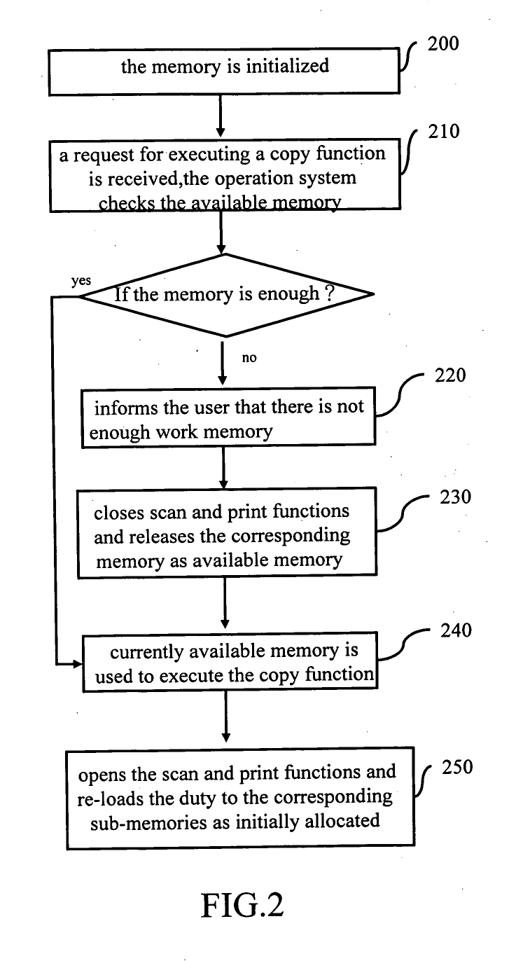

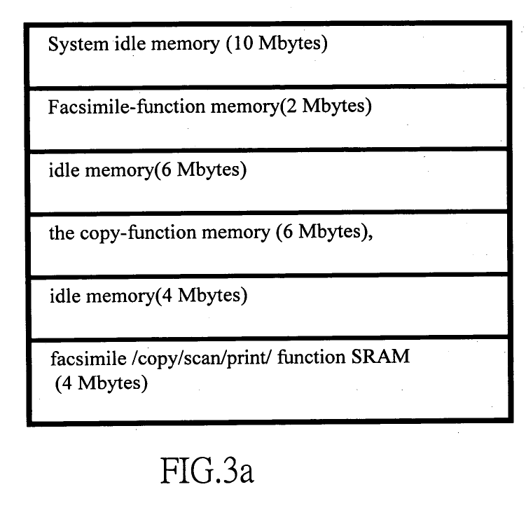

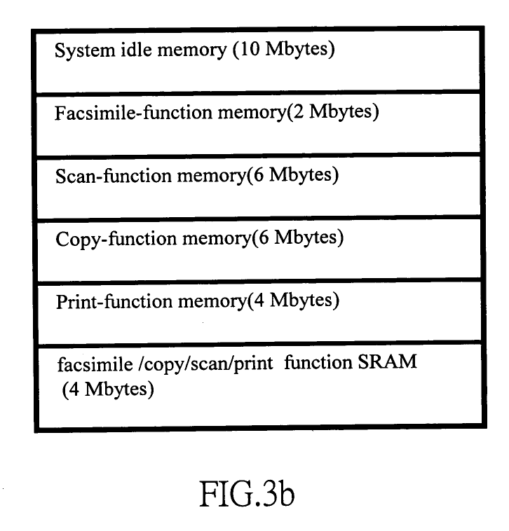

The invention is described by showing a 4-in-one business machine as an example, which can copy, print, scan and do facsimile jobs. FIG. 2 is a flowchart of the memory management of a MFP according to the first embodiment of the invention. The MFP is provided with 32 Mbytes. Firstly the memory is initialized (step 200). An operation of the MFP initializes memory respectively workable for executing copy, print, scan and facsimile functions. If there is no request for executing an appointed function, then the memory is divided into several sub-memories for executing corresponding functions (as shown in FIG. 3a). As soon as a request for executing a copy function is received, the operation system immediately checks the available memory (step 210). The maximum capacity of memory, used for the copy-function execution, is the sum of the system idle memory (10 Mbytes) and the copy-job memory (6 Mbytes), totaling 16 Mbytes. If copying a page needs 400 K bytes, then 16 Mbytes can afford 40-page copies. If more than 40 pages need to be copied, then the operation system of the machine informs the user that there is not enough work memory (step 220). At this time, the operation system automatically finds functions that are not used. For example, if scan and print functions are not used, the operation system automatically closes scan and print functions and releases the corresponding memory as available memory (step 230). At this time, the maximum capacity of available memory consists of the system idle memory (20 Mbytes) and the copy-function memory (6 Mbytes), totaling 26 Mbytes, as shown in FIG. 3b. 26 Mbytes affords about 65-page copies, which will reduce the possibility of insufficient memory. Therefore, the currently available memory can be used to execute the copy function (step 240). If the user starts the scan and print jobs at this moment, the operation system gives indication that the scan and print sub-memories are working for copy-function execution, and can work for their initially allocating functions after the copy operation. After the copy operation, the operation system automatically opens the scan and print functions and re-loads the duty to the corresponding sub-memories as initially allocated (as shown in FIG. 3a) (step 250).

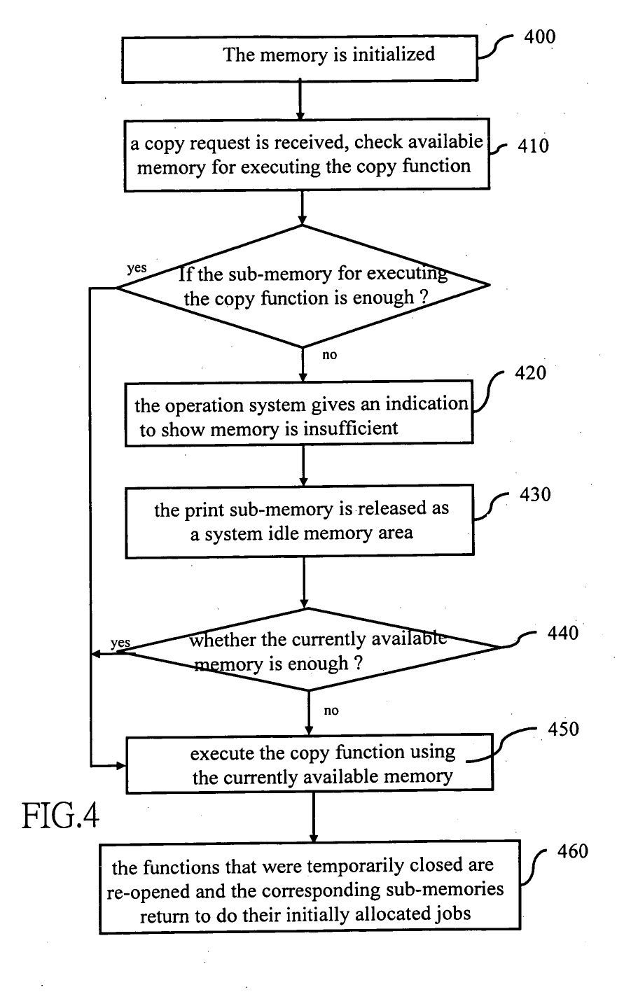

FIG. 4 is a flowchart of a process of memory management according to a second embodiment of the invention. The memory is initialized to allocate the execution of copy-, scan-, print- and facsimile functions in sub-memories (step 400). When a copy request is received, check available memory for executing the copy function (step 410). If the sub-memory for executing the copy function is not enough, then the operation system gives an indication to show such a situation (step 420). The operation system automatically closes at least one currently idle function such as a print function. The function-closed sub-memory (in this case, the print sub-memory) is released as a system idle memory area (step 430). At this moment, the total capacity of available memory for executing a copy function is the sum of the system idle memory and the copy sub-memory. Then, determine whether the currently available memory is enough for executing the copy function (step 440). If NOT, then close the scan function and allocate the scan sub-memory to execute the copy function. If the available memory is sufficient, then execute the copy function using the currently available memory (step 450). If after step 450 the current available memory is still not enough, system will report insufficient memory error to the user. When the copy operation is done, the functions that were temporarily closed are re-opened and the corresponding sub-memories return to do their initially allocated jobs (step 460).

1. A memory management method for a multifunction peripheral, comprising:
receiving a request of executing an appointed function and checking available memory for executing the appointed function;
closing presently idle functions to release corresponding sub-memories; and
allocating the total available memory for execution of the appointed function.

2. The method of claim 1, further comprising a step of initializing the memory.

3. The method of claim 1, further comprising a step of re-opening the closed function.

4. The method of claim 1, wherein the step of closing the presently idle functions includes closing all functions, which are in idle state.

5. The method of claim 1, wherein the step of closing the presently idle functions includes closing one of idle functions.

6. The method of claim 5, further comprising a step of checking presently available memory for execution of the appointed function.

7. The method of claim 6, wherein if the presently available memory is not enough for execution of the appointed function, then repeat the step of closing the presently idle functions.

8. The method of claim 1, further comprising the step of indicating this situation if the available memory is not enough for the job.
